(19) United States
(12) Patent Application Publication
(10) Pub. No.: US 2014/0261291 A1
(43) Pub. Date: Sep. 18, 2014

(54) Rotary Piston Internal Combustion Engine

(71) Applicant: Compound Rotary Engines Limited, Solihull, West Midlands (GB)

(72) Inventor: David W. Garside, Solihull (GB)

(73) Assignee: Compound Rotary Engines Limited, Solihull, West Midlands (GB)

(21) Appl. No.: 14/355,733

(22) PCT Filed: Oct. 18, 2012
(86) PCT No.: PCT/GB2012/052574

§ 371 Date: May 1, 2014

(30) Foreign Application Priority Data
Oct. 23, 2011 (GB) 1118247.4

(51) Int. Cl. F02B 53/02

(52) U.S. Cl. CPC F02B 53/02
USPC 123/200

(57) ABSTRACT

A rotary internal combustion engine of the Wankel type having a housing with a two lobed epitrochoidal inner peripheral surface, a shaft journalled in end housings and a rotor eccentrically mounted on the shaft and geared to rotate at one third the speed of said shaft whereby working chambers are formed between the flanks of the rotor and the housings which vary in volume as the rotor rotates. The rotor is cooled by a fully closed circuit system wherein pressurised gasses are circulated by a centrifugal fan which is directly mounted on the main eccentric shaft, and circulates the gases through a heat exchanger which is integrated into the cool sector of the rotor housing, all components being enclosed within the pressurised system and only one drive shaft using a single high pressure shaft seal assembly emerges from this system.

### DESCRIPTION OF INVENTION

The present invention relates to rotary piston internal combustion engines. More particularly, but not exclusively, the invention relates to a so called Wankel engine in which a rotary piston (so called, and herein referred to as, the rotor) rotates within a cavity formed by a housing or so called rotor housing in combination with end housings or so called end plates, the rotor outer periphery and the inner walls of the cavity being so shaped that working chambers are formed between the rotor and said walls and which vary in volume as the rotor rotates, the cavity being provided with inlet and exhaust ports. In the best known example of an engine of the kind referred to said cavity comprises a stationary rotor housing having a two lobed epitrochoidal shaped bore and a rotor of substantially triangular shape but with convex arcuate flanks, seals or so called apex seals in the apices of the rotor maintaining sealing contact with the peripheral bore of the rotor housing and seals or so called side seals in the sides of the rotor maintaining sealing contact with two axially spaced end plates and the rotor rotating in a planetary manner within the cavity.

Alternative methods of cooling the rotor of an engine of the kind referred to together with the advantages and disadvantages of each system are described in Patent Appln No WO2009/101385.

WO '385 described a rotor cooling system, herein referred to as SPRACS (Self Pressurizing Rotor Air Cooling System) whereby the rotor is cooled by the medium of self-pressurizing blow-by air and gases which have escaped to the interior of the rotor from the working chambers past the side seals, and which are re-circulated in a completely closed circuit by a pump, the cooling medium passing through the rotor where heat is picked up, through ducting and through a heat exchanger where the heat is rejected.

Practical tests with this system have demonstrated that the system does immediately and automatically self-pressurise as described, with the static pressure having typical values in the range 4 to 6 bar absolute when the engine is operating at high power, which is when maximum cooling of the rotor is required. The resulting greatly increased density of the circulating gases removes heat from the rotor in a much more effective manner than any previous system using ambient pressure air or gas to cool the rotor. This is a consequence of the theoretical value of heat transfer coefficient from rotor to the cooling gas and from the cooling gas to the heat exchanger, for a given temperature difference and gas velocity, being typically related to the gas density to the power 0.8.

Sufficient cooling capability still exists with this system even if the pressurised gases are at a much higher average temperature than the unpressurised rotor cooling air used in previous systems.

According to one aspect of the invention, I provide a rotary piston internal combustion engine as set forth in claim 1. Further features which may be provided in embodiments of the invention, and/or aspects of the invention, are set forth in the following description and subsequent claims.

It is an advantage to have a system which correctly cools the rotor but uses a high temperature circulating medium because the heat exchanger whereby the heat is rejected can then be smaller, and the system can still be effective even if the temperature of the medium or surfaces to which the heat is being rejected are quite high. Using SPRACS, the heat exchanger can now be so compact that it is possible to integrate it with the main engine casings and thereby eliminate use of an external heat exchanger, and eliminate use of the external ducting to connect the components that has hitherto been employed, thereby further decreasing bulk, weight, and cost.

The more effective cooling achieved with the high density gases also allows sufficient cooling of the rotor to be still achieved with a pump which circulates the medium at lower velocity through the rotor and heat exchanger, and this lower velocity results in lower flow pressure losses and thereby the pump is required to produce a lower circulating pressure. The preferred type of pump is a centrifugal fan so either the impellor of such a fan can be smaller diameter or the impellor can rotate at a lower angular velocity than hitherto known.

In order to generate the necessary circulating pressure, previous systems have used a small diameter impellor driven at a high rotational speed, several times that of the engine speed, this speed increase being achieved with a belt drive.

The effectiveness of the high density gases in cooling the rotor will allow a fan impellor to be used which has a relatively small diameter, and generally smaller diameter than the main engine casings, thereby assisting in achieving compact packaging; and the impellor to be rotated at engine speed thereby eliminating the need for such a speed-increasing drive and thereby eliminating the cost and bulk and mechanical efficiency losses and torsional vibration problems of such a drive.

One of the disadvantages of using the self pressurizing system involving gas having a pressure of several bar is that each drive shaft which is required to pass through the engine casings must use a high quality rotary shaft seal which is capable of preventing any significant gas leakage during operation of the engine and will continue to provide correct sealing during the full life of the engine.

Hence it is advantageous to use a fan impellor which is directly mounted on or coupled to the engine main eccentric shaft, and which then necessarily rotates at engine speed, the complete fan assembly being fully contained within the high pressure cooling circuit and thereby does not require any drive shaft employing a high pressure rotary seal.

The only shaft which emerges from the complete high pressure system and which therefore requires a high pressure seal is the output drive shaft of the engine.

The Wankel type rotary engine has a rotor housing which is very unevenly heated, the sector around the spark plug and the sector between the spark plug and the exhaust port receiving most heat from the combustion gases.

By using an integrated heat exchanger for the rotor cooling circuit, this invention has an advantageous feature in that the heat from the rotor can be partly rejected into the cold sector of the rotor housing in the region of the inlet port and the induction phase. This heating of the cold sector has two advantages. Firstly it promotes heating of the incoming air/fuel mixture thereby assisting in vaporizing the liquid fuel particles and improving the mixture preparation prior to combustion. Secondly it assists in ensuring that the rotor housing is of more even temperature around the full 360 degree circumference, thereby ensuring more even axial thermal expansion and thereby easing the task of the apex seals in achieving good gas sealing at their axial ends.

Historically, the end plates in a water cooled rotary engine of this type have always incorporated cast cavities through which water has been circulated.

The dense gases which cool the rotor combined with the arrangement of axial flow of the gases entering and leaving the rotor via axial cooling passages through apertures in the end plates close to the centre of these end plates and around their main bearing bosses in the arrangement disclosed in this invention, also remove considerable quantity of heat from the centre of these two end plates. This permits the end plates, of at least quite small rotary engines up to perhaps 500 cc chamber size or thereabouts, to dispense with these water cooling cavities, some of the heat from the side plates being rejected to the gases of the rotor cooling circuit. The remaining heat received by the end plates from the combustion gases in the working chambers is rejected generally by conduction to the adjacent water cooled rotor housing, the heat transfer path being quite short in such small capacity engines. Thereby the construction of the engine is simplified.

Very small chamber size rotary engines are also known wherein no fluid is positively circulated through the rotor to remove heat, the rotor rejecting heat partly via direct conduction to the end plates via their side seals and partly to the cooling effect of the induction mixture impacting the rotor flanks during the induction stroke. For example, a very small 5 cc chamber size engine of this type has been in production for a period of 35 years or more, the application of the engine being to power model aircraft.

Similar but somewhat larger capacity engines up to 75 cc or thereabouts have been built and investigated for powering unmanned aerial vehicles (UAVs) or electrical generators, the difficulties associated with limiting the rotor temperature to satisfactory values increasing with the chamber size as the length of the heat transfer conducting paths thereby increase.

The incorporation of SPRACS, employing much increased density of gas inside the rotor cavities, would allow the rotor in such engines to be maintained at a lower temperature than known hereto by increasing the heat transfer rate from the rotor to the adjacent end plates merely by the agitated movement of these higher density gases as will be created by the rotation of the eccentric shaft and by rotation and orbiting of the rotor. In an alternative version, additional heat rejection may be achieved by the end plates having similar axial openings as the design with circulating fan as previously described herein. In this instance no fan impellor will be fitted but the dense air will be highly agitated by the balance weights which are located in the pressurised cavities immediately adjacent to the external sides of the end plates.

Furthermore, the totally sealed system existing in SPRACS will allow a small quantity of lubricating oil to be injected at a suitable point or points into this pressurised cavity with a rotating balance weight which will then lubricate all bearings of the eccentric shaft and rotor, and all the sliding surfaces of the rotor and side seals in contact with the two end plates, the distribution of the oil particles being assisted by the above mentioned turbulence of the air, before eventually only escaping past the side seals of the rotor into the working chambers of the engine and thereby migrating over the end plate inner surfaces on to the trochoidal surface and thereby lubricating the apex seals before being burnt or ejected through the exhaust port, there being no other route for escape of the supplied oil.

This novel system, in these small capacity engines employing no main centrifugal fan and cooling circuit, may thereby result in six advantages:

a) reduction in rotor temperature,
b) improved lubrication of all the required area,
c) elimination of wet oil particle emission,
d) reduction in supplied oil quantity,
e) ability to use standard commercially available oil types resulting from the lower temperature experienced by the oil,
f) creation of the possibility of building larger capacity engines which do not employ a specific rotor cooling circulation system.

In WO '385, it was foreseen that lubricating oil may gather, or be designed to gather, in a small well in the cooling circuit, and that a pump could be used to return this oil to the oil supply tank. It is now envisaged that an alternative improved system may be to return this small quantity of oil directly to feed hole or holes into the trochoidal surface in the region of the induction stroke (where the working gas pressure is low) and close to the axial centre region of the apex seals, the differential static pressure automatically providing this flow capability with no pump being required, thereby improving the lubrication of the apex seals. It should be noted that the axial outer end portions of the apex seals are well lubricated by oil which escapes from the rotor interior past the side seals of the rotor and which then migrates axially inwards across the trochoidal surface.

However this oil may well be ejected via the exhaust port which typically occupies the axially central third of the trochoidal surface before the oil reaches and lubricates the axially central band which is in contact with the apex seals.

Engines employing these inventions will generally have lubricating oil supplied by a small mechanical oil metering pump which feeds oil into the pressurised gasses of the rotor cooling circuit at a suitable point. These known pumps do not generally have sufficient pressure capability to transfer oil from atmospheric pressure into a system which may have a pressure of 5 bar or so above atmosphere. This problem is overcome by pressurizing the oil tank to the same raised static pressure of the rotor cooling system such that the pump is not required to produce any significant differential supply pressure. It is convenient to mount the pump on the cover that encloses the centrifugal fan, and concentric with the main axis of the engine and fan, and driven by a tang at the rear of the centrifugal fan. No high pressure seal being required on the drive shaft into the pump because all three fluid connections into the pump (via the oil inlet and outlet connections, and the pump drive shaft) are each exposed to identical static pressurization.

Alternatively an electronically-controlled electric solenoid type oil metering pump may be used, such a pump not requiring any mechanical drive.

In WO '385 it was envisaged that a pressure relief or control valve may be fitted to control the static pressure of the rotor cooling gasses to a pressure below the pressure level which naturally occurs in order to ease the problems of correctly sealing the system. This invention, which is using an engine speed fan of limited diameter, will provide increased cooling of the rotor when increased static pressurization exists. Hence it may be preferred to use all of the pressurization which naturally occurs, and no valve is fitted. The system will then be such that, as the load on the engine is increased and the heat input to the rotor consequently increases, the higher static pressure which then automatically occurs in the cooling circuit will enable the then more dense gas to possess greater cooling ability, thereby giving a more ideal automatic control of the temperature of the rotor under all load conditions.

Embodiments of the present invention will now be described with reference to the accompanying drawings in which:—

FIG. 1 is a schematic cross section through a rotary piston engine according to the invention.

FIG. 2 is an axial view of the rotor housing showing the cooling fins in the sector into which the rotor heat is rejected; and the rotor with gas seals and axial cooling passages.

FIG. 3 is an axial view of either side plate showing the openings through which the cooling air passes and which communicate with the cooling passages in the rotor

FIG. 4 shows a section through a small-capacity type of rotary engine which employs no fan assisted circulating system and has no openings in the end plates.

FIG. 5 is similar to FIG. 4 but shows openings in the end plates into closed cavities in which the balancing weights rotate.

Referring to FIG. 1, the engine comprises an eccentric shaft 1 on which is mounted a rotor 101 (shown in FIG. 2), a rotor housing 2 with a finned section 3 and a section with a water jacket 4. End plates 5 and 6 carry rolling element main bearings 9 in which the shaft 1 is rotatably journalled and have axial openings 7 in end plate 6, and 8 in end plate 5. A centrifugal fan impellor 12 with a closing plate or shroud 13 is mounted directly on or coupled to the shaft 1; as illustrated it is mounted on balance weight 30 which itself is mounted directly on the shaft 1. An axial circular wall 15 is integral to the end plate 5 to closely engage with shroud 13 to limit gas leakage at this point.

Balancing weight 31 is mounted on shaft 1 at the drive end 35 is a projection of the shaft 1 which provides the power take off from the engine and this passes through a high pressure shaft seal 11 which is mounted in plate 10. Plate 10 is mounted on end cover 47 which itself is mounted on rotor housing 2. At the non-drive end, cover 46 is mounted on rotor housing 1. Oil metering pump 16 is mounted axially on cover 46.

The outer profile of rotor housing 2, drive end cover 45, seal 11, non-drive end cover 46 and oil pump 16 create a gas tight enclosure inside which the pressurised rotor cooling gases are circulated. These gas flows are shown leaving the centrifugal fan impellor 12, into a volute 40, then at 41 passing through the finned section 3 of rotor housing 2, at 42 emerging from the finned section 3, at 43 passing towards the axial openings 7 in end plate 6, at 44 passing through axial passages in the rotor and then through openings 8 in the end plate 5, and at 45 entering the intake of the centrifugal impellor 12. The oil pump 16 is supplied through a tube 17 from oil tank 18 which is pressurised by tube 19 which is connected into cover 46. The oil supplied by the pump 16 leaves the pump via tube 21 which is connected to tube 20 which supplies oil into the rapidly circulating gas flow 43 and is thereby distributed.

A small well in which may gather a small proportion of the circulating oil particles is shown at 48 from which a tube 49 could feed oil to the trochoidal surface utilising the favourable differential static pressure.

Although FIG. 1 shows the output shaft of the engine emerging from the pressurised cavity at the opposite end to the centrifugal fan, an alternative arrangement could equally well take the drive from the fan end of the engine, the oil metering pump and the output shaft together with shaft seal being interchanged.

FIG. 2 shows the rotor housing 2 with a water cooled sector shown as passageway 62 extending from the water inlet spout 51 in a clockwise direction past the spark plug 53 to the outlet spout 52. The positions of the induction port 60 and the exhaust port 61 are shown.

The cooling fins 3 in FIG. 1 are shown as fins in areas 55, 56, 57, 58, and 59.

The rotor cooling gases leaving the fan impellor 12 and shown as the gas stream 40 in FIG. 1 flow axially through each of the fin areas 55 to 59 in parallel.

In area 55 the gases are generally picking up heat because of conduction into this area from the hot exhaust gases passing though the exhaust port 61. In areas 56 and 57 the gases are being cooled and supplying heat into the area around the cold inlet port. In area 58 the gases are supplying some heat to the cool induction sector of the rotor housing as well as simultaneously being further cooled by conducting heat into the adjacent water passage 62.

In area 59 the gases are generally being cooled by conduction to the water passage 62. The rotor 101 has three side seals 102 on each axial end face of the rotor, three apex seals 103 and six link blocks 104 which engage with the side seals 102 and the apex seals 103.

A rotor bearing bush 105 is press fitted into rotor 101 and is mounted on shaft 1.

Axial cooling passages 106 are located in each corner of the rotor.

FIG. 3 shows an axial view of side plates 5 or 6 in which are mounted main bearings 9 which carry shaft 1. Openings or ports 110 align with the axial passages 106 in rotor 101 in sequence as the rotor eccentrically rotates.

The geometry of Wankel-type rotary engines ensures that the openings 110 are always fully located inside the inner locus of the inner edge of the rotor side seals 102 for all positions of the rotor and thereby allow entry and exit of the rotor cooling gas flows to the cooling passages in the rotor.

In FIG. 4 a rotor housing 71 of the air cooled housing type has cooling fins 72 integrated on the hot sector of the rotor housing which are generally cooled by ram air as in an engine for model aircraft or small UAVs. Alternatively the engine could use liquid cooled housings. End plates 73 and 74 each carry rolling element bearings 78. The main eccentric shaft 75 is rotatably mounted in the two bearings 78 and carries a rotor (not shown) mounted on bearing 95. Balancing weights 76 and 77 are mounted on shaft 75 at the drive end and non-drive end respectively. High pressure seals 91 and 92 are mounted in end plates 73 and 74 and engage with shaft 75.

The cavity inside the rotor is pressurised by blow-by gasses from the working chambers as described in WO '385. The rotation of the shaft and rotor cause turbulence of the pressurised gasses, which thereby increases heat transfer from the rotor to the end plates 73 and 74 thereby reducing the temperature of the rotor to a lower temperature than if the internal cavity was not pressurised.

In FIG. 5 a rotor housing 71 of the air cooled housing type has cooling fins 72 integrated on the hot sector of the rotor housing. End plates 73 and 74 each carry rolling element bearings 78 and generally integrated axial extension walls 93 and 94. The main eccentric shaft 75 is rotatably mounted in the two bearings 78 and carries a rotor (not shown) mounted on bearing 95. Balancing weights 76 and 77 are mounted on shaft 75 at the drive end and non-drive end respectively. A closing plate 81 mounted on wall 94 carries a high pressure shaft seal 82 which engages with shaft 75. An oil metering pump 84 is mounted on closing plate 83 which is mounted on wall 93 concentrically with shaft 75 and driven with via a tang 88. The pump 84 is fed from a pressurised oil tank (not shown) via tube 85. The pump feeds lubricating oil via tube 86 into the cavity 87 and/or 89. Alternatively, via drillings, the oil could be supplied direct to the main bearings 78, or via additional means into the shaft 75 to provide a direct supply to the rolling element rotor bearing 95.

The cavities 87 and 89 and the axial cooling passages inside the rotor are all part of a sealed cavity which is pressurised by blow-by past the side seals of the rotor as described in WO '385. The rotor and the shaft 75 and the balancing weights 76 and 77 all cause considerable motion and turbulence to the dense gasses which are contained in the pressurised cavity thereby increasing the heat transfer rate from the rotor to the gases and thence from the gasses to the inside surfaces of the end plates 73 and 74, and to the inside surfaces of walls 93 and 94, and to the covers 81 and 83. These generally aluminium parts conduct heat readily to their outside surfaces which then reject heat to the external ambient airstreams.

The rotating balancing weights may be so shaped that they maximise the turbulence of the gases, and encourage an interchange of gases to take place, through openings 79, between the heated gases within the rotor cooling passages and the cooler gases within the cavities 87 and 89 and hence increase the rate of heat transfer from the rotor.

Thereby the rotor is cooled to a lower temperature than is currently achieved in this engine type when not using the self-pressurizing system of this invention.

A small well which may gather some oil particles is shown at 48 with an exiting tube 49 which could feed oil to the trochoidal surface.

As an alternative, an engine could be constructed using one side plate assembly as shown in FIG. 4 combined with the other side plate assembly as shown in FIG. 5.

Whilst the invention described with reference to FIGS. 1 to 5 show a single rotor engine, it will be apparent that it is equally applicable to engines of the kind referred to having two or more rotors the gas cooling flows for the multiple rotors generally being arranged to be in parallel rather than in series. However, there being in series is not excluded.

It will be appreciated that modifications may be made to the described embodiments while remaining within the scope of the invention. For example, when we refer to the impellor 12 of the centrifugal from being mounted on the engine shaft, it need not be mounted directly to the shaft but an additional component or components may be utilised to connect the impellor to the shaft to rotate therewith.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A rotary internal combustion engine comprising a housing having a two lobed epitrochoidal inner peripheral surface, end casings for the housing, a shaft journalled in the end casings, a three flanked rotor within the housing mounted on the shaft eccentrically with respect thereto and geared to rotate at one third speed of said shaft whereby working chambers are formed between the rotor flanks and the inner surface of the housing, the rotor having side seals which engage with the inner side faces of the end casings, internal passageways being formed in the rotor which align with a passageway or passageways in each end casing and which form part of a fully closed cooling circuit which includes a cooling heat exchanger, a circulating pump and connecting ducting, the circulating medium effecting the cooling consisting of blow-by gases which have leaked from the working chambers past the side seals of the rotor to the internal passages, and where the circulating pump is a centrifugal fan assembly fully contained inside the high pressure circuit and having an impellor mounted to rotate with the engine shaft at engine speed.

2. A rotary engine as in claim 1 wherein entry to the centrifugal fan impellor is radially aligned with and adjacent to axial openings in the adjacent end plate which allow the hot gases emerging from the rotor to enter the fan axially with minimum flow pressure losses.

3. A rotary engine as in claim 1 wherein the gases exiting radially from the centrifugal fan are guided by a volute or partial volute to then pass axially through a finned sector of the rotor housing which acts as a heat exchanger to cool the gases.

4. A rotary engine as in claim 1 wherein a proportion of the heated gas exiting the rotor is used to increase the temperature of the rotor housing in the region of the peripheral inlet port and the induction chamber.

5. A rotary engine as in claim 1 which incorporates a closing cover which collects the cooled gases emerging from the finned passages in the rotor housing and ducts the gasses to the entry of axial passages in the second end plate via which the cooled gases enter the axial passages in the rotor.

6. A rotary engine as in claim 1 where a mechanical oil metering pump is mounted on the pressure enclosing cover coaxially with the engine mainshaft at the non-drive end of the engine, the pump receiving oil from an oil supply tank which is pressurised via a connecting tube to the same pressure as the rotor cooling system.

7. A rotary engine as in claim 1 wherein a small well is arranged in the rotor cooling circuit which gathers some oil, this well being connected with a small bore tube which supplies some oil direct to the trochoidal surface by means of the favourable differential static pressure which exists.

8. A rotary engine as in claim 1 wherein no pressure relief or control valve is fitted to control the pressurization value of the system.

9. A rotary engine as in claim 1 wherein only one rotating shaft emerges from the pressurised system and only one high pressure shaft sealing arrangement needs to be employed.

10. A rotary internal combustion engine comprising a housing having a two lobed epitrochoidal inner peripheral surface, end casings for the housing, a shaft journalled with rolling element bearings in the end casings, a three flanked rotor within the housing mounted on the shaft eccentrically with respect thereto and geared to rotate at one third speed of said shaft whereby working chambers are formed between the rotor flanks and the inner surface of the housing, the rotor having side seals which engage with the inner side faces of the end casings, the end casings having gas tight rotary shaft seals adjacent to and on the external side of each journal in the end casings which engage with the eccentric shaft, internal cavities being formed in the rotor which are closed by the end plates and which contain pressurised gasses, these gases consisting of blow-by gasses which have leaked from the working chambers past the side seals of the rotor to the internal closed passages of the rotor.

11. A rotary engine as in claim 10, where no shaft seals are fitted in the end plates adjacent to the journals, having axial openings in the end plates, these openings lying within the inner locus of the side seals of the rotor, and each communicate with a cavity outside each end plate which each generally contain a balancing weight of the engine, both of these external cavities being fully closed and one of which incorporates a gas tight shaft seal which engages with the emerging drive shaft.

12. (canceled)
